(19) United States
(12) Patent Application Publication
(10) Pub. No.: US 2015/0375092 A1
(43) Pub. Date: Dec. 31, 2015

(54) METHOD FOR MANUFACTURING BOWLING PIN WITH ADJUSTABLE PROPERTIES, AND PIN

(71) Applicant: RINOTOP OY, Klaukkala (FI)

(72) Inventors: Kaj KERBS, Helsinki (FI); Kari KANNISTO, Halli (FI); Juha MAJA, Kuortane (FI)

(73) Assignee: RINOTOP OY, Klaukkala (FI)

(21) Appl. No.: 14/769,572

(22) PCT Filed: Feb. 21, 2014
(86) PCT No.: PCT/FI2014/050137

§ 371 Date: Aug. 21, 2015

(30) Foreign Application Priority Data
Feb. 22, 2013 (FI) 20135171

(51) Int. Cl. A63D 9/00; B29C 45/00; B27M 3/22

(52) U.S. Cl. CPC A63D 9/00; B27M 3/22; B29C 45/0005; B29C 45/006; B29K 2101/12

(57) ABSTRACT

A method for manufacturing a bowling pin, in which: at least one mass piece is manufactured, and the mass piece is arranged in a body of the pin to adjust the vertical radius of gyration (RG_{V}) and/or vertical moment of inertia (MOI_{V}) of the pin.

### BACKGROUND

The invention relates to a bowling pin the mass, centre of gravity, and/or moments of inertia may be changed and/or adjusted at the stage of manufacturing or assembling the pin, and/or after its assembly.

Ten-pin bowling is a most popular sport and hobby around the world. The pins used in ten-pin bowling have traditionally been made from wood that is coated with plastic. Equipment used in competition ten-pin bowling must meet the regulations set by the USBC (United States Bowling Congress).

The problem in ten-pin bowling is that the level of results of the bowling performance has risen.

### BRIEF DESCRIPTION

The method according to the invention for manufacturing a bowling pin is characterised by what is stated in the characterising parts of the independent claims. Other embodiments of the invention are characterised by what is disclosed in the other claims.

Inventive embodiments are also disclosed in the description and drawings of this application. The inventive contents of the application may also be defined in ways other than those described in the following claims. The inventive contents may also consist of several separate inventions, particularly if the invention is examined in the light of expressed or implicit sub-tasks or in view of obtained benefits or benefit groups. In such a case, some of the definitions contained in the following claims may be unnecessary in view of the separate inventive ideas. Features of the different embodiments of the invention may be applied to other embodiments within the scope of the basic inventive idea.

The idea is that by changing the mass, centre of gravity, and/or moments of inertia it is possible to adjust the difficulty/ease of how a pin falls, and consequently the results level of bowling may be changed to the desired level. A benefit is that changing or adjusting the pin is advantageous compared with changing bowling alleys or bowling balls.

According to an idea, the method for manufacturing a pin is characterised in that the pin is manufactured out of two or more pieces, and by shaping the inner parts of the pin and/or by mass pieces installed in the pin, the centre of gravity and/or moments of inertia and/or mass of the pin may be changed. An advantage is, for example, that the properties of a pin may be accurately determined as early as the manufacturing stage of the pin.

The idea of an embodiment is that adjusting means of the mass piece are arranged in the pin so that the location of the mass piece in relation to the body of the pin may be adjusted from the outside of the pin. A benefit is that the centre of gravity and/or moment of inertia may be changed when the pin is already being used in bowling alleys.

### BRIEF DESCRIPTION OF THE FIGURES

The matter is now described in closer detail in connection with preferred embodiments and with reference to the accompanying drawings, in which

FIG. 1 shows schematically a method for manufacturing a bowling pin,

FIG. 2 is a schematic perspective and cross-sectional view of a pin,

FIG. 3a is a schematic side and cross-sectional view of another pin,

FIG. 3b is a schematic side and cross-sectional view of a third pin,

FIG. 4a is a schematic side and cross-sectional view of a fourth pin,

FIG. 4b is a schematic side and cross-sectional view of a fifth pin,

FIG. 5 is a schematic side and cross-sectional view of a fifth pin,

FIG. 6 is a schematic side and cross-sectional view of a sixth pin.

For the sake of clarity, the figures show the matter in a simplified manner. In the figures, like reference numerals identify like elements.

### DETAILED DESCRIPTION

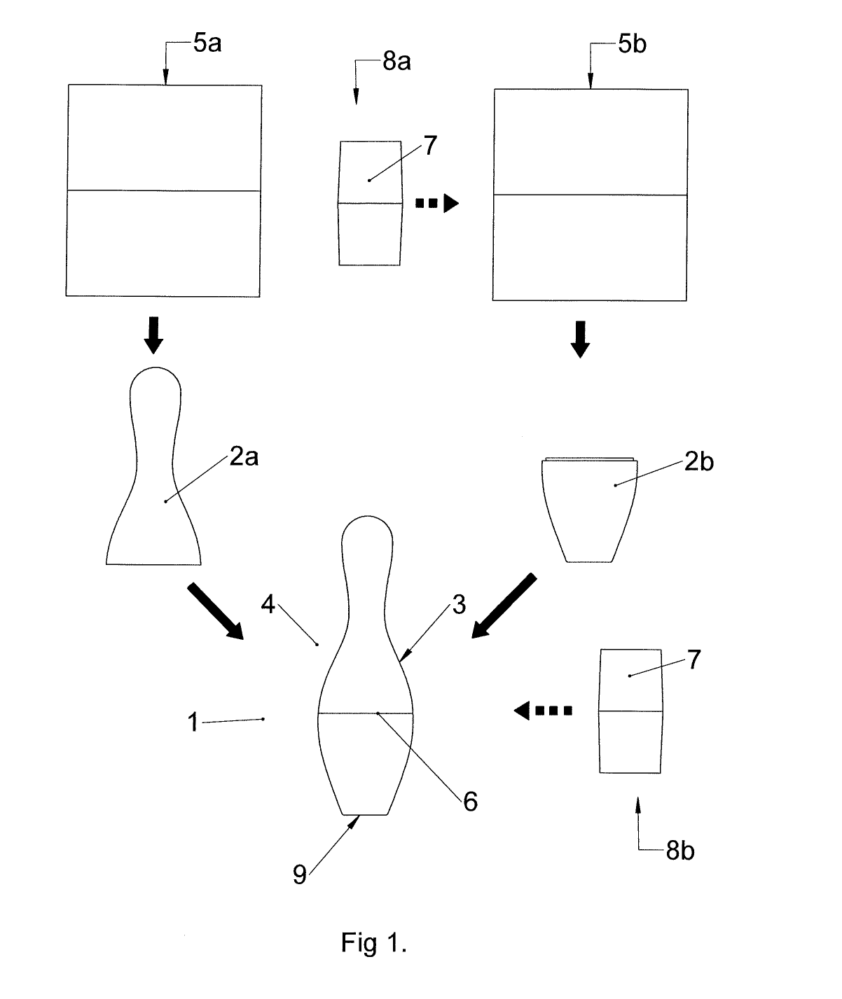

FIG. 1 is a schematic presentation of a method for manufacturing a bowling pin. It is to be noted that the concept “pin” in the present description refers to a pin used in ten-pin bowling. According to an idea, the pin may meet the rules and regulation set by the USBC. According to another idea, the pin may differ from said rules and regulations, but is used in bowling.

In the method, the pin body 1 is manufactured by injection moulding two body parts 2a, 2b of the pin. A first part 2a of the body is injection-moulded in a first mould 5a and, correspondingly, a second part 2b in a second mould 5b. It is to be noted in this connection that the pin body 1 may be formed of a single part or of even more than two body parts.

The injection moulds 5a, 5b may be implemented in manners of implementation of injection moulds known per se. They may comprise, for example, cores or the like.

Said body parts 2a, 2b, once fastened together, may form an outer surface 3 of a pin-shaped body and an interior 4 within the body.

The material used for the body parts 2a, 2b may be plastic or a mixture comprising plastic. According to an idea, the plastic comprises a thermoplast, which is e.g. polyolefin, such as polyethene PE or polypropylene PP, or another thermoplast, such as polyoxymethylene POM, polystyrene PS, acryl-butadiene-styrene ABS or polyamide PA, etc. Typical advantages of a thermoplast include weldability and easy processibility.

According to an idea, the mixture comprising plastic contains natural fibre, e.g. wood fibre, which is most preferably made of hardwood which is typically light in colour and therefore advantageous to apply a colour to, if so desired. The natural fibre may alos comprise softwood fibre, flax fibre, hemp fibre, etc. The share of natural fibre of the mixture is advantageously 5-60 percent by weight, or even more advantageously 10-30 percent by weight.

An advantage of plastic filled with natural fibre is, among other things, its low tendency to form suction while the mixture is cooling down. Owing to this property, the surfaces of the body part 2a, 2b of the pin can be provided with high quality even though the wall thickness of the piece were great. A further advantage is good impact resistance, which makes the life of the pin long. A still further advantage is the option to adjust the properties of the material, such as the elastic modulus (E-modulus), for example. A still further advantage is that natural fibre brings the properties of the pin closer to those of a pin made of wood. Consequently, the properties of the pin closely resemble a wooden pin. Consequently, it is quite simple to manufacture pins that for instance meet the requirements set by the USBC from the material. It is, of course, also possible to manufacture pins of another kind, i.e. pins that are not in accordance with the standards set by the USBC.

By using natural fibre, it is also possible to replace a plastic material, which reduces the raw material costs of the pin.

According to another idea, the plastic comprises a thermosetting plastic, e.g. polyurethane PU. The thermosetting plastic may be filled with natural fibre as already disclosed above. Typically, the advantage of a thermosetting plastic is good resistance to impact and wear.

According to an idea, the body 1 of the pin is manufactured from wood. The manufacturing method may in such a case comprise machining a wooden preform straight into a pin-shaped body 1 by lathing, for example, or manufacturing two or more body parts 2a, 2b separately, which when joined together form the pin body 1. No matter which the manufacturing method of a wooden pin is, the method also comprises the forming of an interior 4. The interior 4 may be formed of shapes formed in the body parts 2a, 2b to be joined, or it may be shaped in the pin-shaped body by milling and/or drilling through a base 9 of the pin, for example.

The material for manufacturing the body parts 2a, 2b may naturally contain other components, such as mineral fillers, colouring agents, injection moulding additives, such as release agents, etc.

One body part 2a, 2b may be made of a different material than the other part 2a, 2b: the materials may e.g. have a different density or the like.

In FIG. 1, the body parts 2a, 2b to be manufactured are shaped such that the division plane 6 between them is horizontal with respect to the complete pin body 1. The first part 2a forms the upper part of the pin body 1 while the second part 2b forms the lower part of the pin body 1. It is also possible to shape the parts 2a, 2b and arrange the division plane 6 in a different manner. Further below in this description, a solution is disclosed wherein the division plane is vertical; in addition, the division plane 6 may be arranged obliquely with respect to the horizontal and vertical direction, or it may comprise parts that are arranged in mutually parallel or mutually intersecting space planes. For instance, the division plane 6 may be provided with a tongue-and-groove joint, or other corresponding shapes which contribute to the attachment between the body parts 2a, 2b.

In addition to the body parts 2a, 2b, the method may comprise manufacturing one or more mass pieces 7.

Such a mass piece 7 may be manufactured e.g. from the materials used in the manufacture of the body parts: nevertheless not necessarily from a material having exactly the same components as that used for the body parts 2a, 2b in question. The mass piece 7 may also be manufactured from another kind of material based on plastic, plastic composite, metal or ceramic, for instance.

The mass piece 7 may be manufactured e.g. by injection moulding, pressing or some other manufacturing method known per se. The mass piece 7 may have a solid, hollow, or angular structure.

FIG. 1 shows two alternative ways to arrange a mass piece 7 in a pin: in the first method alternative 8a, the mass piece 7 is arranged in a mould 5b prior to injecting a mixture forming a body part into said mould 5b. Of course, the mass piece may be arranged in a first mould 5a or mass pieces may be arranged in both moulds.

In the second method alternative 8b, the mass piece 7 is arranged in a body interior 4. This arranging may be carried out either prior to attaching the body parts 2a, 2b to one another, or only after said attachment to one another has been performed. In the latter embodiment, the outer surface 3 of the body of the pin comprises an opening via which the mass piece may be arranged in the interior 4. The opening may be arranged in the base 9 of the pin, for instance.

By means of the mass piece 7, the vertical radius of gyration RG_{V} and the vertical moment of inertia MOI_{V} corresponding to it, as well as the horizontal radius of gyration RG_{H} and the horizontal moment of inertia MOI_{H} corresponding to it, of the pin 1 can be set as desired.

The centre of gyration of RG_{V} is parallel to the vertical axis of revolution as the pin is standing in its vertical position on a horizontal plane and passes through the centre of gravity of the pin.

The centre of gyration of RG_{H} is parallel to the axis of revolution on a horizontal plane as the pin is standing in the normal manner in its vertical position on a horizontal plane, and passes through the centre of gravity of the pin.

According to USBC, the concepts radius of gyration, RG, and moment of inertia, MOI, refer to the following:

“Radius of gyration, RG: Measured in inches, radius of gyration is the distance from the axis of rotation at which the total mass of a body might be concentrated without changing its moment of inertia.

Moment of Inertia, MOI: Resistance to change in rotation.”

The USBC standard only deals with horizontal values, that is, it only recognizes RG_{H} and MOI_{H} as the factors affecting the properties of a pin.

RG_{V}, MOI_{V}, RG_{H} and MOI_{H} are of utmost importance from the point of view of the behaviour of the pin during actual bowling. However, the importance of RG_{V} and MOI_{V}, in particular, on the pin behaviour has not so far been recognized.

The larger the RG or MOI of the pin, the more force the pin requires to start rotating. In addition, the small friction between the alley and the pin base as well as between the bowling ball and the pin obviously makes it harder for the pin to fall and consequently lowers the results level.

In addition, according to an idea, the mass piece 7 may be used to adjust the mass of the pin and the location of the centre of gravity. The lower the centre of the gravity of the pin is, the harder the pin is to knock down.

The total mass of the pin also plays a major role in the behaviour of the pin. It is more difficult to make a heavier pin fall than a lighter pin. It is particularly difficult to knock down make a pin which has a large RG_{V} and MOl_{V}, which is heavy, and which has its centre of gravity as low as possible.

By using variations of the mass, shape, and position of the mass piece 7, it is possible on the one hand to manufacture pins that contribute to providing a beginner-level bowler with a pleasant bowling experience, and on the other hand pins that require top-level know-how and experience to fall.

The body parts 2a, 2b may be attached to one another in numerous ways. They may for instance be glued or welded together, or a mechanical fastening, e.g. a crimp connection or a threaded connection, or various combinations thereof, may be used.

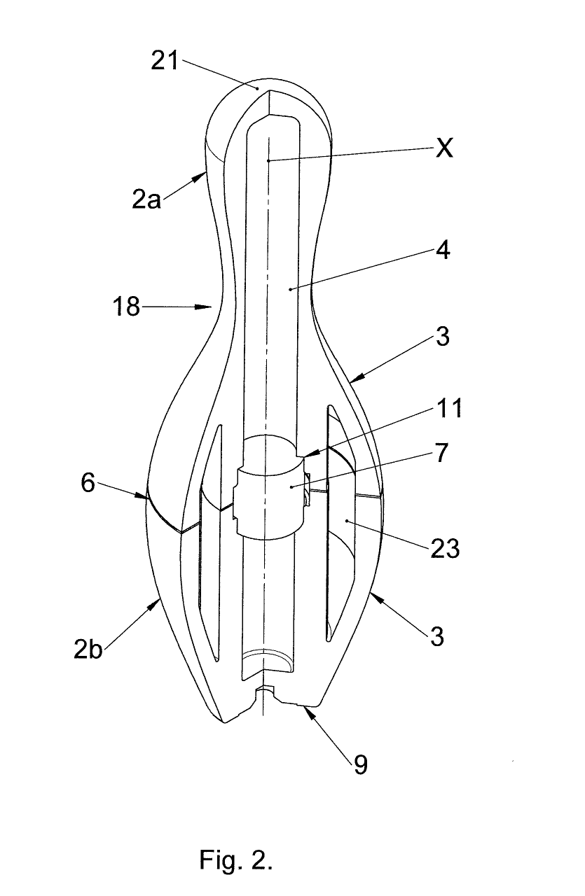

FIG. 2 is a schematic perspective and cross-sectional view of a pin. The pin in question may be manufactured by the method according to FIG. 1, for example.

The body parts 2a, 2b are preferably manufactured so that the division plane 6 between them resides higher or lower than the impact plane of a bowling ball. Thus, the impacts of the bowling ball are not directly applied to the joint in the division plane 6. The division plane 6 may, of course, also be arranged in the impact plane of the bowling ball.

The pin comprises an interior 4 which is closed, in other words, has no link to the outer surface 3 of the pin, not even the base 9. The internal shapes of the body parts 2a, 2b needed to form the interior 4 may be manufactured in moulds with the aid of a moving core, for example. In the embodiment shown in FIG. 2, the interior 4 has the shape of an annular cylinder extending from about the pin base 9, pass the pin neck 18, close to the pin top 21.

It should be noted in this context that the interior may alternatively have the shape of another cylinder than an annular cylinder. Its shape may also be conical, ellipsoid, or similar. According to an idea, all of the interior 4 is arranged below the pin neck 18. This way, it is possible to avoid weakening the structure of the thinnest part of the pin.

In addition to the interior 4, a pin may also have other hollow parts, such as the hollow space 23 surrounding the interior 4 in the pin of FIG. 2. The hollow space 23 may decrease the pin mass and affect the behaviour of the pin in a bowling event. Filling material may be arranged in the hollow space 23, if so desired.

The mass piece 7 is arranged in the interior 4, which may be provided with fit forms 11 to keep the mass pieces 7 in place. In such a case, the mass piece 7 has a cylindrical external form.

The mass piece 7 may be part of the fastening system of the body parts 2a, 2b. It may e.g. be glued to the body parts 2a, 2b and/or it may comprise forms so as to provide form locking or a crimp connection with the body parts 2a, 2b.

The body parts 2a, 2b may be connected to each other by welding or gluing, for example.

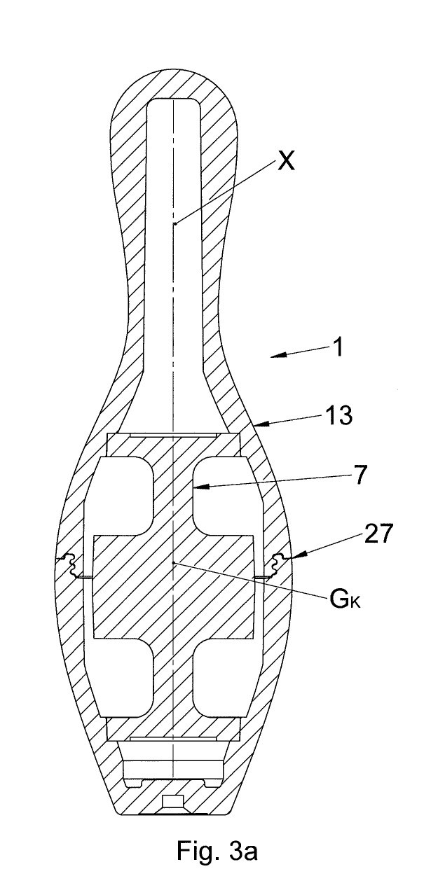

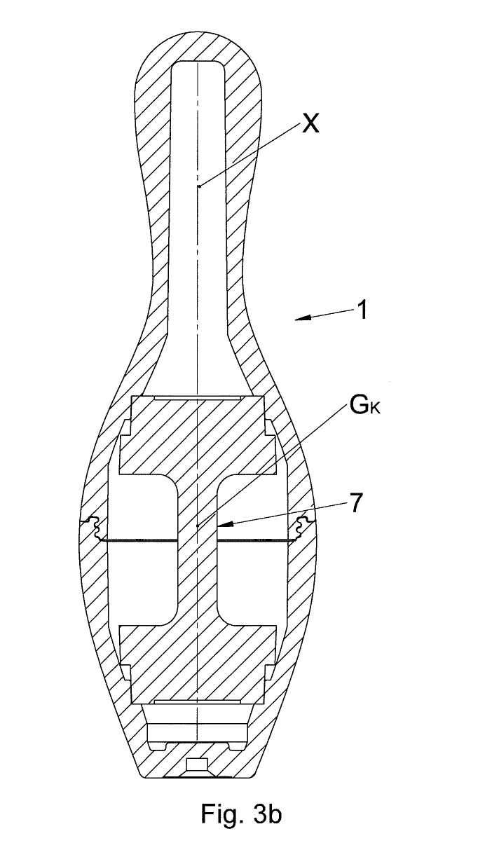

FIG. 3a is a schematic view of another pin, and FIG. 3b is a sectioned side view of a third pin.

The pin body 1 comprises two body parts 2a, 2b whose division plane 6 is horizontal with respect to a finished pin. The parts 2a, 2b are interconnected in the division place 6 by a threaded joint 27. In this, glue, a welded seam, or another similar element improving the adhesion may be added.

The interconnected body parts 2a, 2b form the interior 4, which is concentric with respect to the vertical centre axis of the pin, and which has a shape that essentially adapts to the external form of the pin. Consequently, the wall thicknesses of the body parts 2a, 2b are essentially the same throughout the entire pin.

In the interior 4, a mass piece 7 has been arranged, which is mounted by its ends to the body parts 2a, 2b. This way, the mass piece 7 may act as the connecting piece that connects the body parts 2a, 2b to one another.

The mass of the mass piece 7 is located very close to the centre of gravity Gₖ of the pin, directly around it. This allows the moment of inertia for the pin to fall, that is, MOI_{H}, to be small whereby the pin 1 falls more easily than the pin shown in FIG. 3b, for example.

The RG_{H} and MOI_{H} of the pin 1 shown in FIG. 3b are substantially larger than those of the pin of FIG. 3a. This has been achieved with the mass piece 7 whose mass is placed as far as possible from the centre of gravity Gₖ of the pin, as seen in the vertical direction. The bulk of the mass is arranged right at the ends of the mass piece.

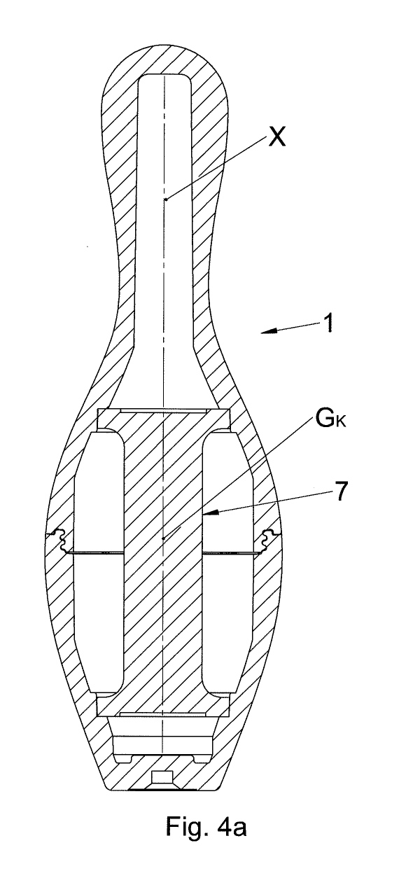

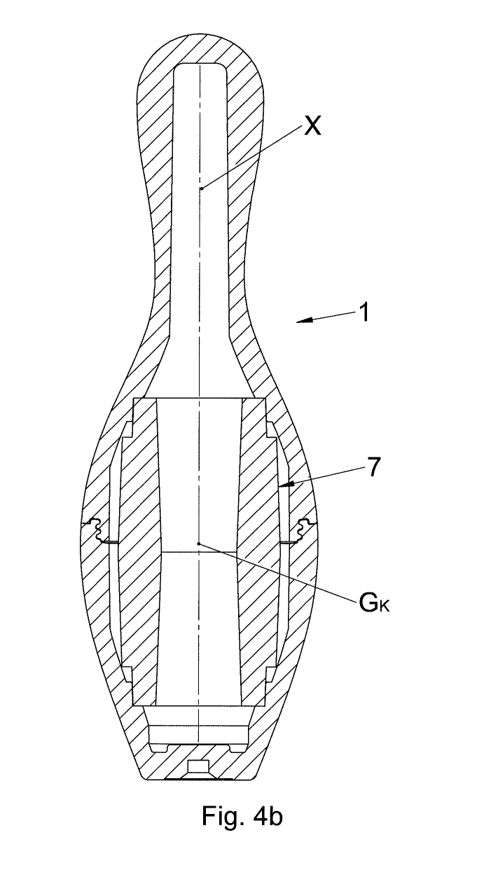

FIG. 4a is a schematic view of a fourth pin, and FIG. 4b is a sectioned side view of a fifth pin. The parts 2a, 2b forming the body of the pin 1 may have the exact same dimensions, masses, and other properties as those presented in the pins of FIGS. 3a, 3b. Instead, there is a difference in the mass pieces 7, this difference causing the pins 1 shown in FIGS. 3a, 3b, 4a, 4b to behave essentially differently with respect to each other during bowling.

The bulk of the mass in the mass piece 7 of the pin 1 shown in FIG. 4a is arranged close to the vertical centre axis X of the pin 1, but essentially equally along the length of the mass piece 7. Such a mass piece 7 provides the pin with a small moment of inertia for the rotation motion whose centre of gyration is the vertical centre axis X, that is, the RG_{V} and MOI_{V} of the pin are small.

In FIG. 4b, the bulk of the mass in the mass piece 7 is arranged as far from the vertical centre axis X of the pin 1 as possible, but essentially equally along the length of the mass piece 7. Such a mass piece 7 provides a pin with a large moment of inertia for the rotation whose centre of gyration is the vertical centre axis X, that is, the RG_{V} and MOI_{V} of the pin are large.

The dimensions of the mass pieces 7 of FIGS. 3a, 3b, 4a, 4b are in the most advantageous case congruent in the places where they are connected to the parts 2a, 2b. Thanks to this, it is possible to manufacture standard-form pin body parts 2a, 2b, no matter which mass piece 7 shown in FIGS. 3a, 3b, 4a, 4b is mounted to them. It is obviously clear that several, different kinds of mass pieces 7 with different mass distributions can be manufactured, enabling several variations for MOI_{H} and MOI_{V} of the pin 1.

The mass pieces 7 of FIGS. 3a, 3b, 4a, 4b may be rotationally symmetrical pieces with respect to the vertical centre axis X, but alternatively at least somewhat asymmetric up to the point where the asymmetrical distribution of mass affects the rotation of the pin. In such a case, the rotating motion of the pin is varying and unstable. In addition, the mass of the mass piece 7 may be asymmetrically distributed in the direction of the centre axis X of the pin: for example, the mass concentrations at the ends of the mass piece 7 of FIG. 3b can therefore be not only equal in mass but also unequal.

The pins 1 of FIGS. 3a, 3b, 4a, 4b can be equal as regards their other properties, in other words, their mass, location of the centre of gravity etc. can be mutually identical. This makes it possible to manufacture a plurality of pin versions having different properties in a very simple manner.

The outer surface 3 of the pin body 1 may be coated with a coating layer 13, which may consist e.g. of a thermoplastic or a thermosetting plastic, such as that produced by the product name Surlyn. The material constituting the coating layer may comprise a colouring agent. Typically, a pin is white in colour, but this is not the only colour alternative for a pin. The outer surface 3 may be of one or more colours. The colouring agent may comprise components which, upon exposure to UV light, produce a certain visual effect. Such an effect may be particularly attractive in glow bowling. According to an idea, the coating layer may comprise soil repellent, e.g. photoactive, components.

The coating layer 13 may have a constant thickness or it may have areas of different thicknesses. According to an idea, within the area of the impact point of the bowling ball the coating layer 13 is thicker than elsewhere. The coating layer 13 may be made of the same material throughout, or of a different material in different parts of the pin. The coating layer 13 may comprise one or more layers of different material. The purpose of the coating layer 13 may be e.g. to influence the appearance of the pin, protect the body of the pin, and/or affect the frictional properties of the outer surface of the pin. The coating layer 13 and/or the outer surface 3 of the body of the pin may comprise patterns, recesses, protrusions, etc.

The coating is naturally applicable to the other embodiments disclosed in this description.

The base 9 of the pin may also be provided with different patterns or different coatings in order to change the friction between the base and a bowling lane. The patterns of the base 9 are also applicable to the other pin embodiments disclosed in this description.

The pins shown in FIGS. 3a-4b are manufactured without a separate base ring. This makes the manufacturing process of the pin simpler. Of course, a separate base ring may also be used in the pins in question.

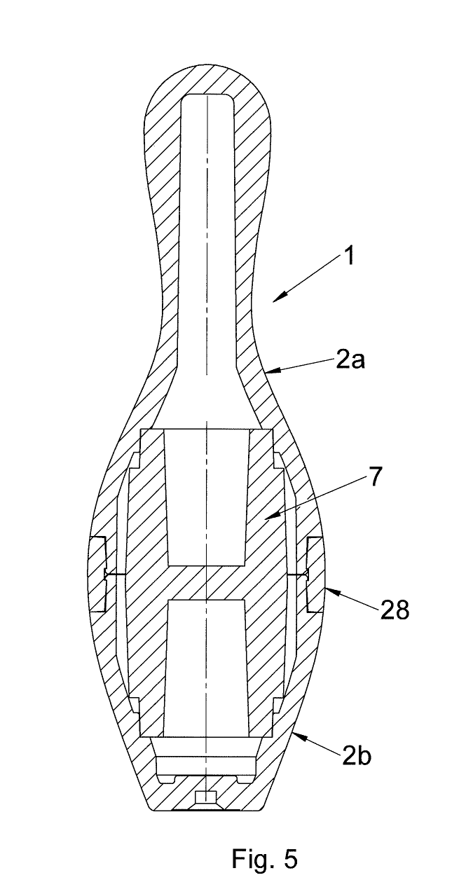

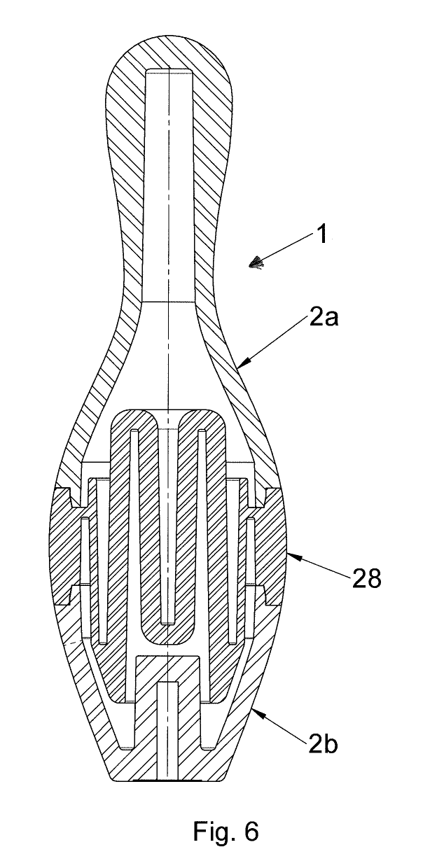

FIG. 5 is a schematic view of a fifth pin, and FIG. 6 is a sectioned side view of a sixth pin. The most essential difference of these pins to the ones presented in the previous drawing is that the pin body comprises a third part 28, arranged between the first and second part 2a, 2b. Features of the mass piece 7 have already been described in the above.

The third part 28 shown in FIG. 5 is a ring, which is arranged in the division plane 6 between the first and second part 2a, 2b. The third part 28 enforces the joint between the first and second part 2a, 2b. The third part 28 may be manufactured from the aforementioned production materials of parts 2a, 2b, and it can be mounted in the pin 1 in ways that were already referred to in the above. The third part 28 may be manufactured by injection moulding or by detaching it from a tube made of a suitable material.

In the pin 1 shown in FIG. 6, the third part 28 is incorporated into the mass piece 7. This way the number of parts in the pin 1 may be reduced.

The third part 28 is advantageously manufactured of a particularly strong material that enforces the point of impact, that is, the point that the bowling ball hits as it meets a pin 1 standing upright.

The aforementioned pin 1 parts: body parts 2a, 2b, mass piece 7 and the third part 28 may be manufactured of masses having different specific gravities. The body parts 2a, 2b may, for example, be manufactured of a material with a lighter specific gravity than the mass piece. The variations in material selection add to the options of adjusting the pin mass, centre of gravity as well as radius of gyration and moment of inertia without the need to manufacture a plurality of moulds for the various parts of a pin.

In summary, the method of the invention is characterised by: manufacturing at least one mass piece, and arranging said mass piece in a pin body to adjust the radius of gyration and/or moment of inertia of the pin.

In some cases, features disclosed in this application may be used as such, regardless of other features. On the other hand, when necessary, features disclosed in this application may be combined in order to provide different combinations.

The drawings and the related description are only intended to illustrate the idea of the invention. It is apparent to a person skilled in the art that the invention is not restricted to the embodiments described above, in which the invention is described by means of some examples, but many modifications and different embodiments of the invention are possible within the scope of the inventive idea defined in the following claims.

### REFERENCE NUMERALS

1 pin
2a, b part of pin body
3 outer surface of body
4 interior
5a, b mould
6 division plane
7 mass piece
8a, b method alternative
9 base of pin
10 tongue-and-groove joint
11 fit form
12 groove of mass piece
13 covering layer
16 first threaded part
17 second threaded part
18 neck of pin
19 mating base
20 opening of interior
21 tip of pin
22 handle
23 hollow space
24 flange-like protrusion
25 scale
26 locking means
27 threaded joint
28 third part
G_{K} centre of gravity of pin
G_{M} centre of gravity of mass piece
H_{K} height of centre of gravity of pin
H_{M} height of centre of gravity of mass piece
X vertical centre axis

1-13. (canceled)

14. A method for manufacturing a bowling pin, comprising the steps of:
manufacturing at least one mass piece; and
arranging said mass piece in the body of the pin in order to adjust the vertical radius of gyration (RG_{V}) and/or the vertical moment of inertia (MOI_{V}) of the pin.

15. The method as claimed in claim 14, further comprising the step of adjusting, by the use of said mass piece, also the horizontal radius of gyration (RG_{H}) and/or the horizontal moment of inertia (MOI_{H}) of the pin.

16. The method as claimed in claim 14, wherein the mass piece is manufactured asymmetric so that the radius of gyration (RG_{H}, RG_{V}) and/or moment of inertia (MOI_{H}, MOI_{V}) of the pin may be adjusted by the position of the mass piece in relation to the body of the pin.

17. The method as claimed in claim 14, wherein an interior is made in the body of the pin to accept the mass piece, and the mass piece is arranged in said interior.

18. The method as claimed in claim 17, further comprising the step of manufacturing, in the pin body, a standard-form interior to accept the mass piece, by manufacturing a set of mass pieces that fit the standard form of the interior, and by arranging, in the interior, a mass piece that sets the radius of gyration (RG_{H}, RG_{V}) and moment of inertia (MOI_{H}, MOI_{V}) of the pin to what is desired.

19. The method as claimed in claim 14, wherein the pin body is made partly or entirely of plastic or a mixture comprising plastic.

20. The method as claimed in claim 19, further comprising the step of manufacturing the pin body by injection-moulding so that said mass piece is arranged in a mould forming the body or a part thereof before plastic or the mixture comprising plastic is injected in said mould.

21. The method as claimed in claim 19, wherein the mixture comprising plastic contains natural fibre.

22. The method as claimed in claim 21, wherein the natural fibre is wood fibre.

23. The method as claimed in claim 22, wherein the wood fibre is hardwood fibre.

24. The method as claimed in claim 14, further comprising the step of manufacturing the pin body partly or entirely of wood.

25. The method as claimed in claim 15, further comprising the step of manufacturing the pin body partly or entirely of wood.

26. The method as claimed in claim 16, further comprising the step of manufacturing the pin body partly or entirely of wood.

27. The method as claimed in claim 17, further comprising the step of manufacturing the pin body partly or entirely of wood.

28. The method as claimed in claim 18, further comprising the step of manufacturing the pin body partly or entirely of wood.

29. The method as claimed in claim 14, further comprising the steps of:
manufacturing at least two body parts which, when fastened together, form a pin-shaped outer surface of the body and the interior inside of the body; and
arranging the mass piece in said interior.

30. The method as claimed in claim 14, further comprising the step of manufacturing the interior at a distance from the base of the pin.

31. The method as claimed in claim 14, further comprising the step of arranging the entire interior below the neck of the pin.

32. A pin used in bowling, said pin being manufactured by the method according to claim 14.
